(19) United States
(12) Patent Application Publication
(10) Pub. No.: US 2024/0412124 A1
(43) Pub. Date: Dec. 12, 2024

(54) PROCESSING DEVICE, GENERATION METHOD, AND STORAGE MEDIUM

(71) Applicant: KABUSHIKI KAISHA TOSHIBA, Tokyo (JP)

(72) Inventor: Yusuke SHIMADA, Yokohama Kanagawa (JP)

(21) Appl. No.: 18/806,179

(22) Filed: Aug. 15, 2024

Related U.S. Application Data
(63) Continuation of application No. PCT/JP2022/006709, filed on Feb. 18, 2022.

(51) Int. Cl. G06Q 10/0631

(52) U.S. Cl. CPC G06Q 10/06311

(57) ABSTRACT

According to one embodiment, a processing device is configured to refer to a first area corresponding to a work area where multiple tasks related to multiple articles is performed, the first area including multiple of sections. The processing device is further configured to refer to multiple objects corresponding to the multiple articles. A size and a duration of the task are set for each of the multiple objects. The processing device is further configured to generate a task plan by using the multiple sizes and the multiple durations. The task plan includes placements of the multiple objects in the first area, and a sequence of the multiple placements. The processing device is further configured to calculate an evaluation value based on a state of the first area after placing at least one of the multiple objects, and determine the multiple placements and the sequence based on the evaluation value.

### CROSS-REFERENCE TO RELATED APPLICATIONS

This is a continuation application of International Patent Application PCT/JP2022/006709, filed on Feb. 18, 2022. The entire contents of which are incorporated herein by reference.

### FIELD

Embodiments described herein relate generally to a processing device, a generation method, and a storage medium.

### BACKGROUND

There is a device that generates a task plan including the placements of multiple articles in a work area, the sequence of the placements, etc., for multiple tasks related to the articles. It is favorable to shorten the work period during which the multiple tasks are performed. It is desirable for the device to be able to generate a task plan having a shorter work period.

### BRIEF DESCRIPTION OF THE DRAWINGS

FIG. 1 is a schematic view illustrating a configuration of a processing system according to an embodiment.

FIGS. 2A to 2C are schematic views for describing the processing according to the processing device according to the embodiment;

FIGS. 3A to 3F are schematic views for describing the processing according to the processing device according to the embodiment;

FIGS. 4A and 4B are schematic views for describing the processing according to the processing device according to the embodiment;

FIGS. 5A to 5F are schematic views for describing the processing according to the processing device according to the embodiment;

FIG. 6 is a schematic view for describing the processing according to the processing device according to the embodiment;

FIGS. 7A to 7C are schematic views for describing the processing according to the processing device according to the embodiment;

FIG. 8 is a schematic view for describing the processing according to the processing device according to the embodiment;

FIGS. 9A and 9B are schematic views for describing the processing according to the processing device according to the embodiment;

FIGS. 10A to 10C are schematic views for describing the processing according to the processing device according to the embodiment;

FIG. 11 is a schematic view for describing the processing according to the processing device according to the embodiment;

FIGS. 12A and 12B are schematic views for describing the processing according to the processing device according to the embodiment;

FIGS. 13A to 13C are schematic views for describing the processing according to the processing device according to the embodiment;

FIGS. 14A to 14C are schematic views for describing the processing according to the processing device according to the embodiment;

FIG. 15 is a flowchart illustrating the generation method according to the embodiment;

FIG. 16 is a flowchart illustrating the generation method according to the embodiment;

FIG. 17 is a flowchart illustrating the generation method according to the embodiment; and

FIG. 18 is a block diagram illustrating a hardware configuration of the processing device according to the embodiment.

### DETAILED DESCRIPTION

According to one embodiment, a processing device is configured to refer to a first area corresponding to a work area where a plurality of tasks related to a plurality of articles is performed, the first area including a plurality of sections. The processing device is further configured to refer to a plurality of objects corresponding to the plurality of articles. A size and a duration of the task are set for each of the plurality of objects. The processing device is further configured to generate a task plan by using the plurality of sizes and the plurality of durations. The task plan includes placements of the plurality of objects in the first area, and a sequence of the plurality of placements. The processing device is further configured to calculate an evaluation value based on a state of the first area after placing at least one of the plurality of objects, and determine the plurality of placements and the sequence based on the evaluation value.

Various embodiments will be described hereinafter with reference to the accompanying drawings.

In the specification and drawings, components similar to those described or illustrated in a drawing thereinabove are marked with like reference numerals, and a detailed description is omitted as appropriate.

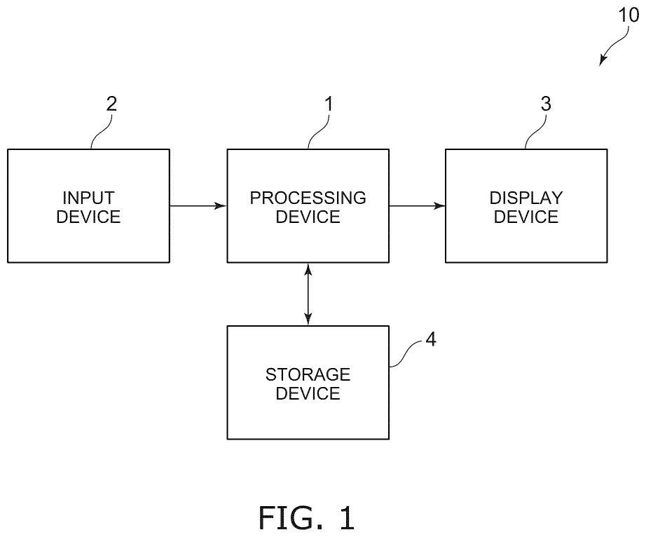

FIG. 1 is a schematic view illustrating a configuration of a processing system according to an embodiment.

As illustrated in FIG. 1, the processing system 10 includes a processing device 1, an input device 2, a display device 3, and a storage device 4.

The processing system 10 is used to generate a task plan related to multiple tasks. The multiple tasks are performed in a specific work area. In one task, one article is placed in at least a portion of the work area, and a task related to the one article is performed. For example, the task is connecting, cutting, assembling, disassembling, polishing, cleaning, etc., of the article. The article is a device, a unit included in a portion of the device, a component included in a portion of the unit, etc.

The processing device 1 appropriately refers to data that is prepared beforehand, and generates a task plan to complete the multiple tasks in a shorter work period. The processing device 1 is, for example, a general-purpose computer that includes a central processing unit (CPU).

The user uses the input device 2 to input data to the processing device 1. For example, the input device 2 includes at least one selected from a mouse, a keyboard, a touchpad, and a microphone.

The display device 3 displays the data output from the processing device 1 so that the user can visually check the data. For example, the display device 3 includes at least one selected from a monitor and a projector. A device such as a touch panel or the like that includes the functions of both the input device 2 and the display device 3 may be used as the input device 2 and the display device 3.

The storage device 4 stores data necessary for generating the task plan, data generated by the processing according to the processing device 1, etc. For example, the storage device 4 includes at least one selected from a hard disk drive (HDD), a solid-state drive (SSD), and a network-attached hard disk (NAS).

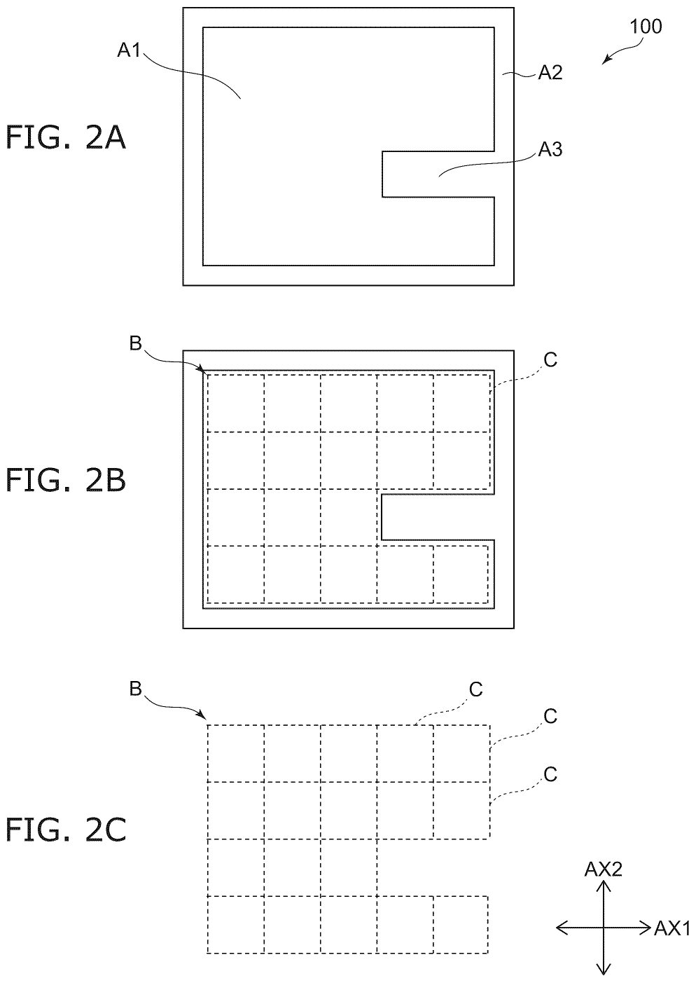

FIGS. 2A to 14C are schematic views for describing the processing according to the processing device according to the embodiment.

The processing according to the processing device 1 will now be described with reference to FIGS. 2A to 14C. Here, an example will be described in which the two-dimensional placement of each article and the sequence of the placements are determined.

First, a first area and multiple objects are generated and stored in the storage device 4 by the user. The user also stores, in the storage device 4, the start time of the entire work, the deadline of the entire work, etc. The first area is the data corresponding to the work area. The multiple objects are data corresponding respectively to the multiple articles which are the task objects.

FIG. 2A is a schematic view showing an actual work area. The work area A1 is surrounded with a wall A2 and a column A3. As illustrated in FIG. 2B, the user generates a first area B that corresponds to the work area A1. As illustrated in FIGS. 2B and 2C, the first area B includes multiple sections C in which the tasks can be performed. The sections C are represented by quadrilaterals.

The multiple sections C are arranged along a first-axis direction AX1 and a second-axis direction AX2 that cross each other. For example, the first-axis direction AX1 is perpendicular to the second-axis direction AX2. The first-axis direction AX1 and the second-axis direction AX2 correspond to horizontal directions of the work area.

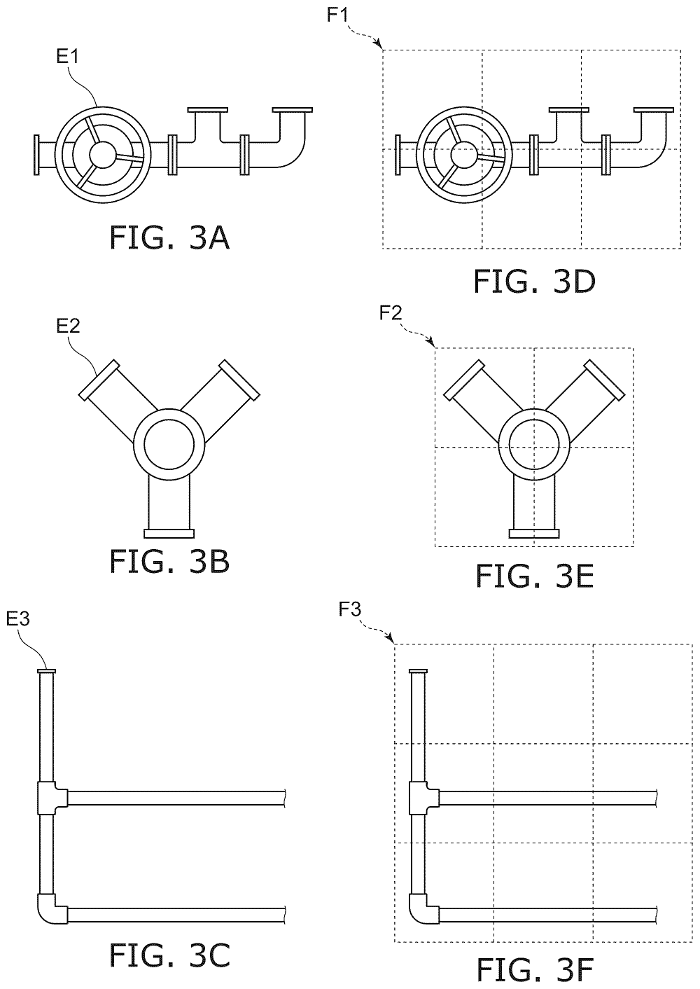

In the generation of the object, the user sets the size of the object and the duration of the task for the article corresponding to the object. The size is set in units of the section C. For example, articles E1 to E3, which are the pipes illustrated in FIGS. 3A to 3C, are made by welding and assembling in the work area. As illustrated in FIGS. 3D to 3F, the user generates objects F1 to F3 corresponding to the articles E1 to E3. The size of the object F1 is represented by sections arranged 2 long×3 wide. The size of the object F2 is represented by sections arranged 2 long×2 wide. The size of the object F3 is represented by sections arranged 3 long×3 wide.

The size of the object may include space necessary for the task. For example, when a large device or the like is adjacent to the article during the task, the size of the device is included in the size of the object. When a wide workspace is necessary, the size of the workspace is included in the size of the object. When it is necessary to perform the task on the article from a specific direction, the size of the object in that direction is set to be greater than the size of the actual article.

The number of sections set for the work area is arbitrary. The number of sections is set according to the performance of the processing device 1. The likelihood of generating a more favorable task plan increases as the number of sections increases. For example, a task plan that has a shorter work period may be generated. The calculation amount can be reduced by reducing the number of sections. For example, the task plan can be generated more quickly, even when there are many tasks.

For example, as illustrated in FIGS. 3D to 3F, the exterior shapes of the objects are quadrilaterals. By representing all of the articles with quadrilaterals, the calculation amount necessary to generate the task plan can be reduced. Or, the exterior shapes of the objects may be five-or-higher-sided polygons. For example, many sections may be set for a quadrilateral work area; and objects may be set more to minutely reflect the shapes of the actual articles, the spaces necessary for the tasks, etc. As a result, the likelihood of generating a more favorable task plan is high.

According to the first area and the multiple objects that are prepared, the processing device 1 generates a task plan that includes the placements of the objects in the first area and the sequence of the placements. “Placement” includes the position at which the object is placed and the orientation of the object. When generating the task plan, the processing device 1 calculates evaluation values of the first area before placing the objects and after placing one of the objects. The evaluation values are based on the states of the first area before placing the objects and after placing one of the objects. The processing device 1 determines the placements and the sequence based on the evaluation values.

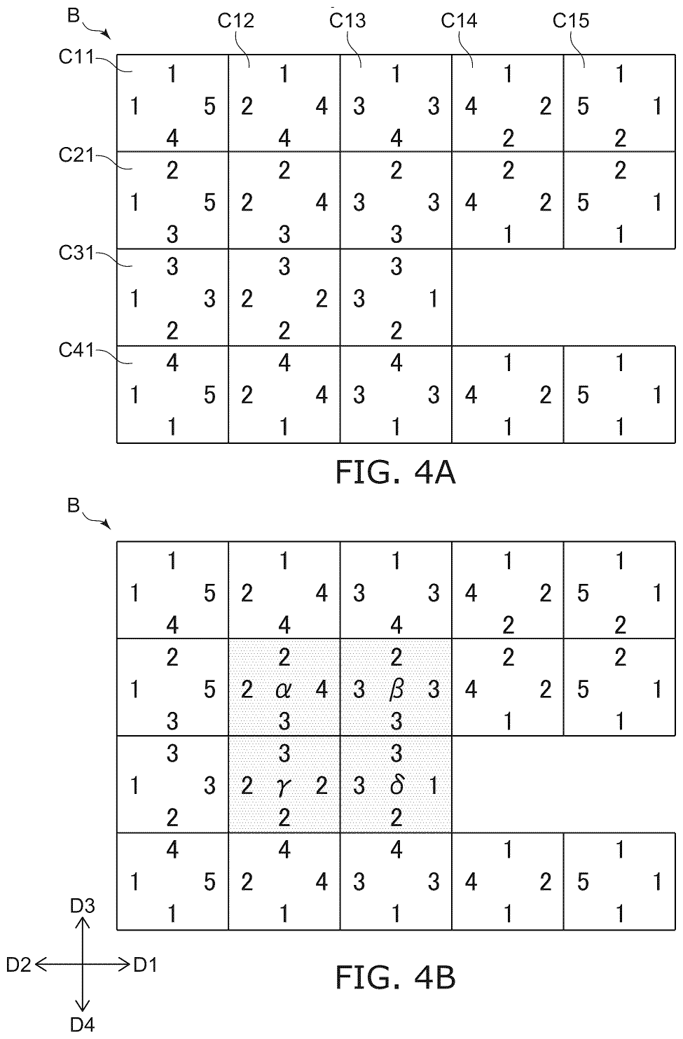

The determination of the placements and the sequence based on the evaluation values will now be described with reference to FIGS. 4A to 6.

First, the processing device 1 calculates the evaluation value before placing the objects. The evaluation value is determined based on the placeable distances calculated for each section.

Specifically, the processing device 1 calculates, for each section, the placeable distances in first to fourth directions D1 to D4. The placeable distance represents the upper limit of the size of an object that can be placed in the direction when the object is placed at one section. The first direction D1 and the second direction D2 are opposite to each other and parallel to the first-axis direction AX1. The third direction D3 and the fourth direction D4 are opposite to each other and parallel to the second-axis direction AX2. To simplify the following description, the first direction D1 is called “right”. The second direction D2 is called “left”. The third direction D3 is called “up”. The fourth direction D4 is called “down”.

As an example, as illustrated in FIG. 4A, the upward, downward, leftward, and rightward placeable distances are calculated for each section. In the example, the placeable distance is expressed by the number of the sections C. For example, an object that has a size of the five sections of sections C11 to C15 can be placed in the rightward direction at the section C11. Objects that have a size of the one section of the section C11 can be placed in the leftward and upward directions. An object that has a size of the four sections of the sections C11 to C41 can be placed in the downward direction. Therefore, for the section C11, the placeable distances in the rightward, leftward, upward, and downward directions are calculated respectively to be “5”, “1”, “1”, and “4”.

The processing device 1 selects one object to be placed in the first area. The object may be randomly selected, or may be selected according to a preset priority or rule. The processing device 1 refers to the placeable distances and extracts the sections at which the selected object can be placed.

For example, the object F1 that has a size of 2 long×3 wide illustrated in FIG. 3D is selected. The processing device 1 refers to the placeable distances of the sections C. The processing device 1 extracts the sections C that have the same placeable distance as the size of the object F1. As a result, as illustrated in FIG. 4B, the processing device 1 extracts sections α, β, γ, and & as sections at which the object F1 can be placed.

At the section α, the object F1 can be placed leftward and downward from the section α. At the section β, the object F1 can be placed leftward and upward from the section β. Also, the object F1 can be placed rightward and upward from the section β. For the section γ, the object F1 can be placed leftward and upward from the section γ. Also, the object F1 can be placed rightward and upward from the section γ. At the section δ, the object F1 can be placed leftward and downward from the section δ.

The processing device 1 also determines whether or not the area of the unoccupied sections in the placement area when the object F1 is placed in the extracted sections C is equal to the area of the object F1. The unoccupied sections are sections at which no object is placed. The area can be expressed by the number of sections. When an obstacle such as the column A3, another object, or the like is placed in the area in which the object F1 is to be placed, the area of the unoccupied sections in the area is less than the area of the object F1. The placement for which the area of the unoccupied sections in the area is less than the area of the object F1 is determined to be impracticable, and is excluded. In the example of FIG. 4B, the area of the unoccupied sections in the area in which the object F1 is to be placed is equal to the area of the object F1 for the placements of the sections α, β, γ, and δ. Therefore, these placements each are determined to be practicable.

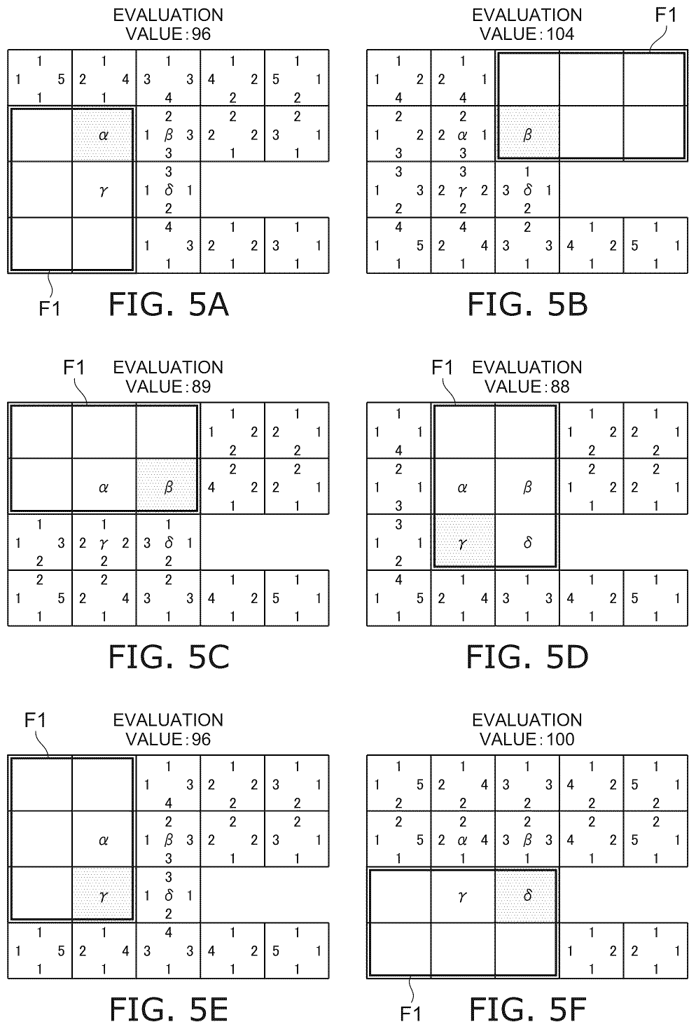

As illustrated in FIGS. 5A to 5F, the processing device 1 places the object F1 with placeable orientations at the extracted sections α, β, γ, and δ. The processing device 1 recalculates the placeable distances of the sections C after placing the object F1. The sections C in which the object F1 is placed have placeable distances of zero in all directions. FIGS. 5A to 5F illustrate the placeable distances of the sections when the object F1 is placed at the sections α, β, γ, and δ.

The processing device 1 calculates the evaluation value based on the placeable distances. For example, the evaluation value is the sum of the placeable distances in each direction for all sections. The evaluation value may be calculated using the average, product, etc., of all of the placeable distances. FIGS. 5A to 5F illustrate the evaluation values when the object F1 is placed at the sections α, β, γ, and δ.

The processing device 1 compares the multiple evaluation values and extracts the placement having the best evaluation value. In the example, the placement of the object F1 rightward and upward from the section β has the highest evaluation value. The processing device 1 determines the rightward and upward placement from the section β to be the placement of the object F1.

As in the example of FIG. 4B and FIGS. 5A to 5F, the object is placed in the sections so that the placeable distances match the size of the object. As a result, the object can be placed proximate to the corners of the first area B. After placing the object, another object is easily placed in the first area B. For example, the necessary calculation amount can be less than when the evaluation values are calculated by extracting all sections and orientations at which the object can be placed.

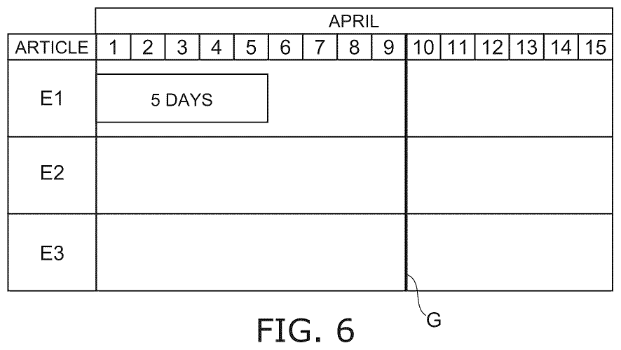

The processing device 1 refers to the duration of the task for the object F1. The processing device 1 inputs the duration of the task to a schedule. In the example illustrated in FIG. 6, the start date of the task is set to April 1st. The duration of the task for the object F1 is set to five days. The processing device 1 inputs the task of the article E1 corresponding to the object F1 in the schedule from April 1st for five days.

The deadline of the multiple tasks may be set. In the example illustrated in FIG. 6, a deadline G of the multiple tasks for the articles E1 to E3 is set to April 9th.

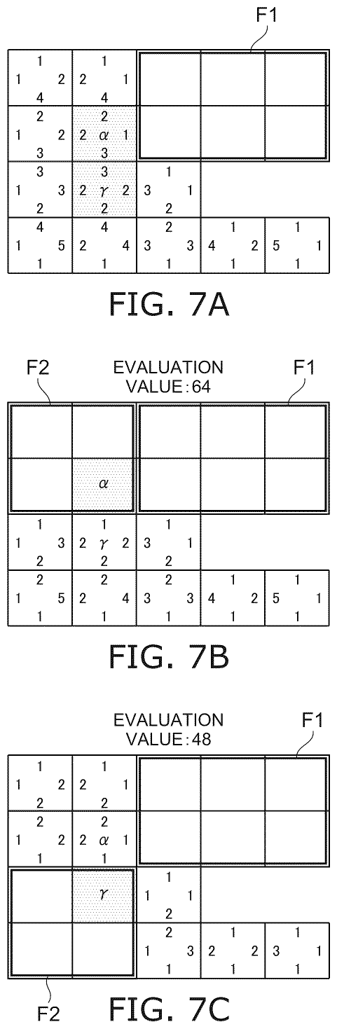

Thereafter, the processing described above is repeated until the placement is determined for all of the objects. For example, the object F2 is selected after the object F1. The processing device 1 extracts the sections at which the object F2 can be placed in the first area B after placing the object F1. As illustrated in FIG. 7A, the sections α and γ are extracted as sections at which the object F2 can be placed.

As illustrated in FIGS. 7B and 7C, the processing device 1 calculates the placeable distances and the evaluation values after placing the object F2 at the sections α and γ. As a result of the calculation, the highest evaluation value is obtained for the placement of the object F2 at the section α. The processing device 1 determines the section at which the object F2 is placed to be the section α.

The processing device 1 refers to the duration of the task for the object F2. The object F2 can be placed in the first area B simultaneously with the object F1. In other words, the task for the object F2 can be performed simultaneously with the task for the object F1. Therefore, the processing device 1 sets the start date of the task for an article E2 corresponding to the object F2 to be the same April 1st as the start date of the task for the article E1, and inputs the article E2 to the schedule. Thereafter, similar processing is repeated for the remaining object F3.

Here, it is assumed that the resources sufficient for performing the task are available. The resources are the personnel, equipment, tools, etc., for performing the task. Constraints of the resources may be set. For example, the resources necessary for the objects may be set. The available resources are set when generating the task plan. The earliest time at which the resources will be available is set by the processing device 1 as the start time of the task for each object.

The placements of the objects are determined while referring to the state of the first area B at different times. After the duration of the task has elapsed, the processing device 1 removes the object from the first area. As a result, larger objects can be placed in the first area. After an object is selected, if there are no sections at which the object can be placed, the processing device 1 advances the referenced time. By advancing the time, one of the objects is removed, and a new object can be placed.

For example, as illustrated in FIG. 7B, when the object F2 is placed at the section α, there are no sections at which the object F3 can be placed. The placements of the objects F1 and F2 shown in FIG. 7B represent the state at the start time of the tasks. The processing device 1 advances the referenced time from the start time at a preset interval. For example, the referenced time is advanced each day. The processing device 1 refers to the state of the first area each time the referenced time is advanced. The processing device 1 calculates the placeable distances of the sections at different times, and determines whether or not an object can be placed.

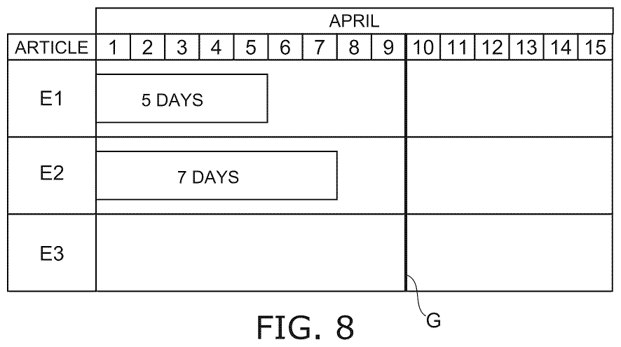

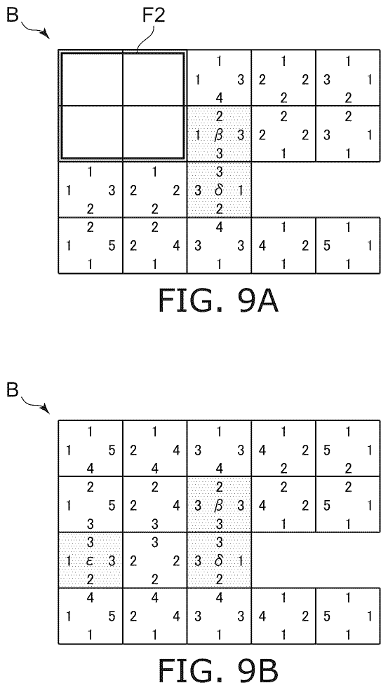

Based on the schedule illustrated in FIG. 8, the object F1 is not present on April 6th. FIG. 9A illustrates the state of the first area after the object F1 is removed. As illustrated in FIG. 9A, the processing device 1 calculates the placeable distances of the sections. The processing device 1 extracts sections at which the object F3 can be placed based on the calculation result of the placeable distances.

In the example illustrated in FIG. 9A, from the perspective of the placeable distances, the object F3 can be placed at the sections β and δ. However, when placed at either the section β or δ, the area of the unoccupied sections in the area in which the object F3 is placed is less than the area of the object F3 due to the presence of the object F2 or the column A3. Therefore, the processing device 1 determines that there are no sections at which the object F3 can be placed.

The processing device 1 further advances the referenced time. Based on the schedule illustrated in FIG. 8, the objects F1 and F2 are not present on April 8th. FIG. 9B illustrates the state of the first area after the objects F1 and F2 are removed. Based on the calculation result of the placeable distances illustrated in FIG. 9B, the processing device 1 extracts the sections at which the object F3 can be placed. As a result, the sections β, δ, and ε are extracted as sections at which the object F3 can be placed.

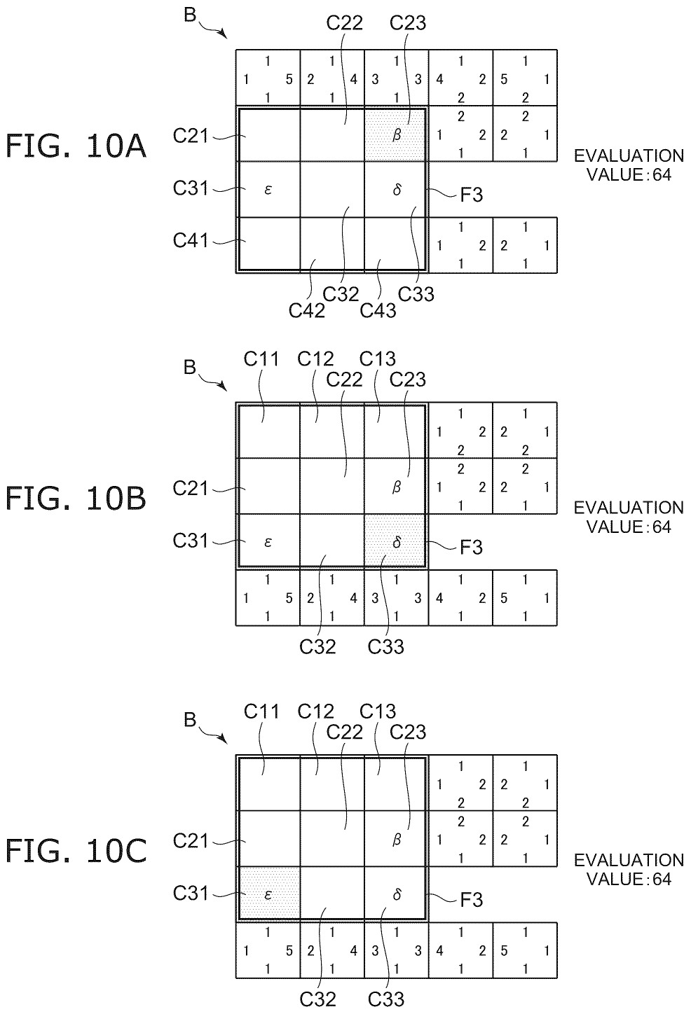

After extracting the sections at which the object can be placed, the processing device 1 may check the sections that are occupied when the object is placed in the extracted sections. For example, as illustrated in FIG. 10A, sections C21, C22, C23, C31, C32, C33, C41, C42, and C43 are occupied when the object F3 is placed leftward and downward from the section β. As illustrated in FIGS. 10B and 10C, the sections C11, C12, C13, C21, C22, C23, C31, C32, and C33 are occupied when the object F3 is placed leftward and upward from the section δ and when the object F3 is placed rightward and upward from the section ε.

As illustrated in FIGS. 10B and 10C, the sections occupied when the object F3 is placed at the section δ are the same as the sections occupied when the object F3 is placed at the section ε. When the occupied sections are the same for each of multiple placements, the processing device 1 determines that the placements are equivalent. The processing device 1 selects one of the multiple placements, and adopts only the selected placement. The selection may be according to a rule or may be random. For example, each section is marked with an identification number; and the section having the smallest identification number is selected. By selecting one placement from multiple equivalent placements, fewer task plans may be generated. As a result, the time and effort of the user checking the task plan can be reduced.

For example, the processing device 1 determines that the placement of the object F3 at the section δ is equivalent to the placement of the object F3 at the section ε. The processing device 1 selects the section δ from the sections δ and ε. Subsequently, the processing device 1 calculates the placeable distances and the evaluation values after the object F3 is placed at the sections β and δ. As a result of the calculation, the evaluation values are equal when placed at either the section β or δ.

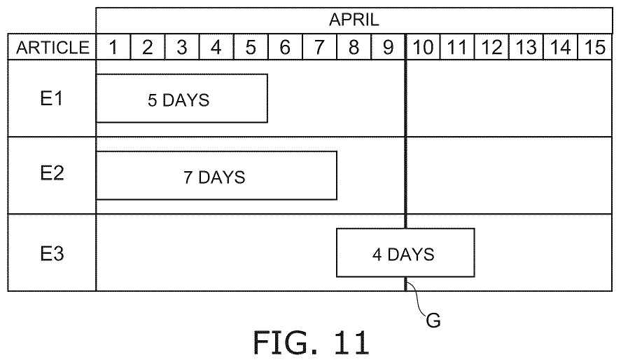

The processing device 1 determines the sections β and δ each as sections at which the object F3 could be placed. In such a case, a task plan when the object F3 is placed at the section β and a task plan when the object F3 is placed at the section δ are generated. As illustrated in FIG. 11, the processing device 1 inputs, to the schedule, the duration of the task for the object F3 for each task plan. The processing device 1 determines that the completion time for all of the tasks is April 11th. One or more task plans are generated by the processing described above. The task plan includes the sequence of the placements of the objects F1, F2, and F3, the placements of the objects, and the schedule of the tasks.

Or, the processing device 1 may select one placement from multiple placements having equal evaluation values. Here, a case where an object F4 is placed after the object F3 will be described as an example. The size of the object F4 is represented by sections arranged 2 long×2 wide. The processing device 1 calculates the placeable distances of the sections for the case where the object F3 is placed at the section β and the case where the object F3 is placed at the section δ. For each case, the processing device 1 extracts the sections at which the object F4 can be placed based on the placeable distances. When no sections can be extracted at which the object F4 can be placed for either case, the processing device 1 advances the referenced time until a section can be extracted at which placement is possible. When a section can be extracted at which the object F4 can be placed for one case, the processing device 1 adopts the placement of the object F3 for the one case. When a section can be extracted at which the object F4 can be placed for two or more cases, the processing device 1 compares the evaluation values after the object F4 is placed for each case.

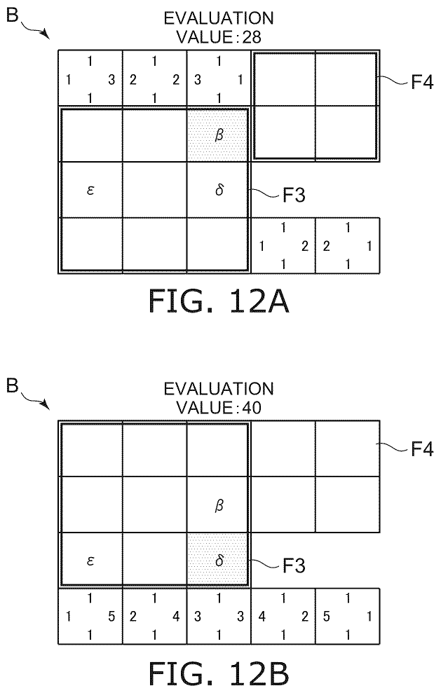

For example, FIG. 12A illustrates the placement of the object F4 after the object F3 is placed at the section β. FIG. 12B illustrates the placement of the object F4 after the object F3 is placed at the section δ. For each case, the processing device 1 calculates the placeable distances of the sections after placing the object F4, and calculates the evaluation value. By comparing the two evaluation values, it can be seen that a higher evaluation value after placing the object F4 is obtained when the object F3 is placed at the section δ. Based on the evaluation value comparison, the processing device 1 determines the placement of the object F3 to be the section δ.

The processing device 1 determines the placement of the object F4 after determining the placement of the object F3. In such a case, the placement of the object F4 was already calculated when selecting the placement of the object F3. The processing device 1 determines the placement of the object F4 after the object F3 is placed at the section δ by referring to the calculation history.

As described above, when multiple placements have equal evaluation values, a task plan having a shorter work period is easily obtained by considering the placements of subsequent objects when selecting one placement from the multiple placements. Also, the number of task plans that are generated can be reduced, and the time and effort of the user checking the task plans can be reduced.

The processing device 1 repeats the processing described above while modifying the selection sequence of the objects. For example, the processing device 1 generates multiple task plans by performing the processing described above for all possible sequences. As a result, the placements of the objects and the schedule of the tasks are obtained for each sequence.

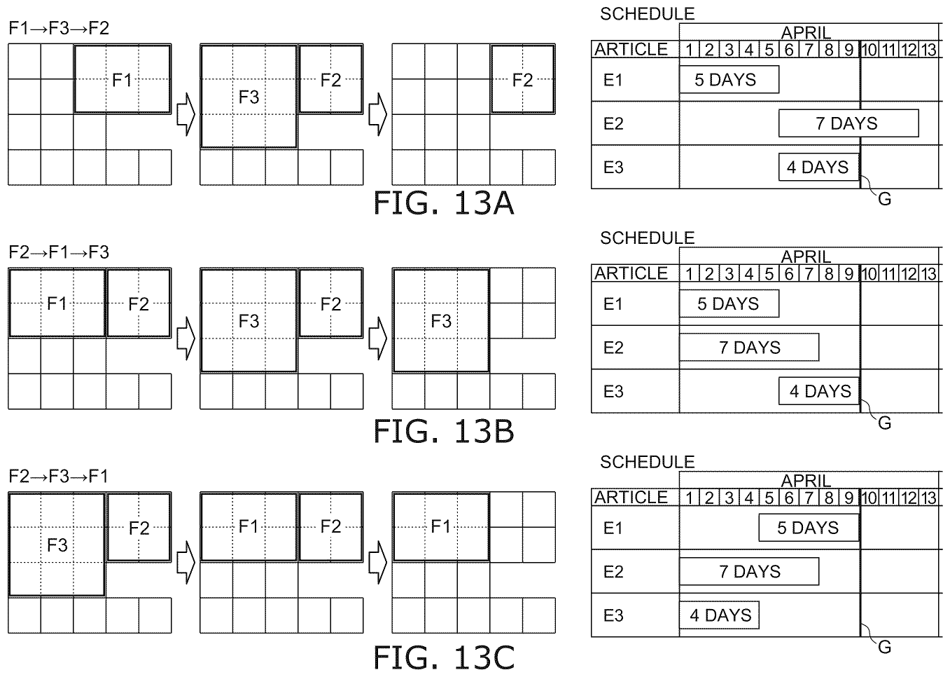

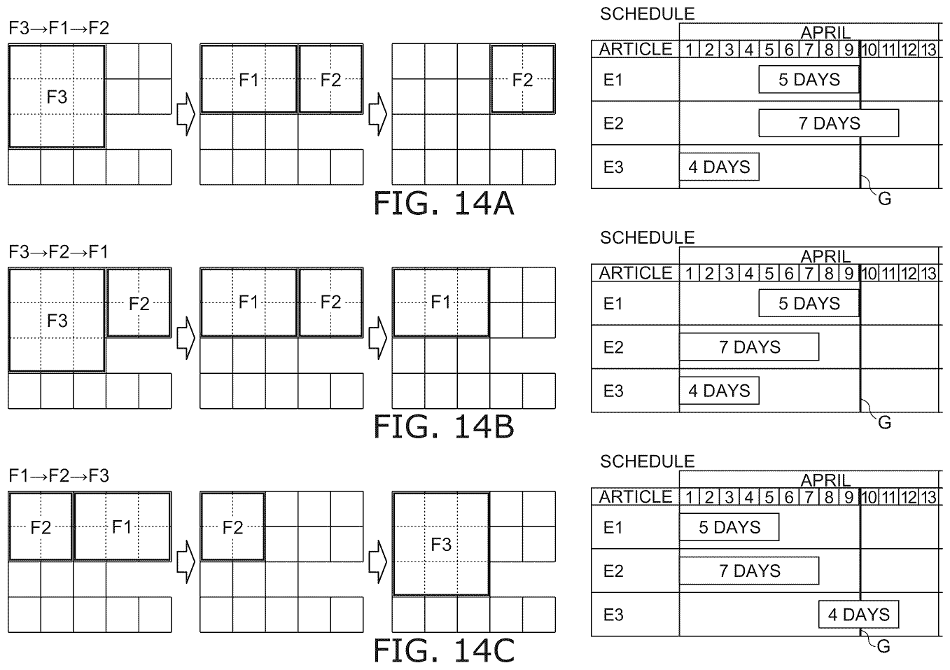

FIGS. 13A to 13C and FIGS. 14A to 14C illustrate multiple task plans generated by the processing device 1. For example, the processing device 1 outputs the multiple task plans. The task plans each include the sequence of the placements, the placements of the objects, the times when the objects are placed, and the schedule. The schedule shows the relationship between the sequence of the placements and the time. For example, the work period is shown by the schedule. The display device 3 displays the data output from the processing device 1. For example, the display device 3 displays the results illustrated in FIGS. 13A to 13C and FIGS. 14A to 14C.

The processing device 1 may compare the multiple task plans obtained with the deadline G. The processing device 1 extracts one or more task plans from the multiple task plans obtained in which all of the tasks can be completed within the deadline G. The processing device 1 outputs the extracted task plan. As a result, the user can select the task plan to be utilized while comparing the one or more task plans that can meet the deadline G.

The processing device 1 may extract the task plan having the shortest work period from the multiple task plans obtained. Specifically, the task plan having the shortest work period is the task plan having the earliest completion time. The processing device 1 outputs the extracted task plan. As a result, the user can easily ascertain the task plan with the shortest possible work period.

As illustrated in FIGS. 13A to 13C and FIGS. 14A to 14C, the processing device 1 may cause the display device 3 to display the states of the first area when placing the objects. As a result, the user can easily ascertain the states of the first area partway through the task plan.

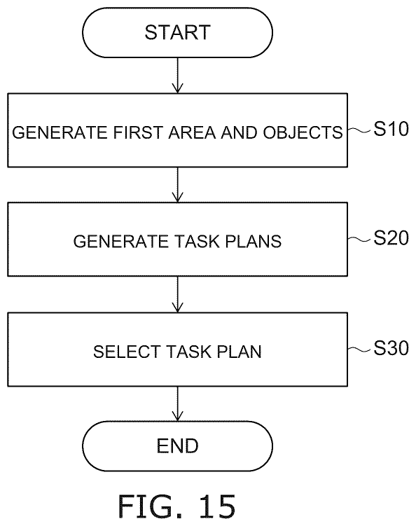

FIGS. 15 to 17 are flowcharts illustrating the generation method according to the embodiment.

As illustrated in FIG. 15, first, the user generates the first area and multiple objects (step S10). The size and the duration of the task are set for each object. The processing device 1 generates one or more task plans based on the first area and the multiple objects (step S20). For example, the processing device 1 selects one task plan (step S30).

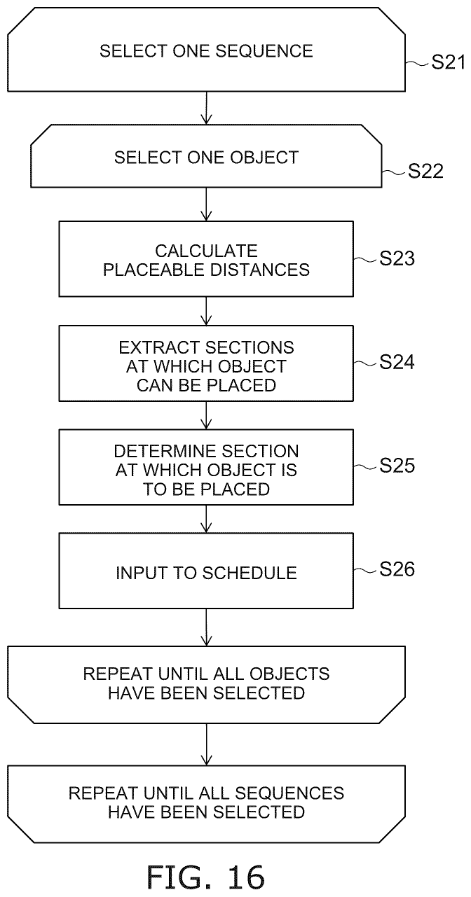

The processing illustrated in the flowchart of FIG. 16 is performed to generate the task plan. First, the processing device 1 selects one sequence from multiple sequences of the placements (step S21). Then, the processing device 1 selects one object according to the selected sequence (step S22). Before placing the selected object, the processing device 1 calculates the placeable distances in four directions for all of the sections (step S23). The processing device 1 extracts the sections at which the object can be placed based on the calculation result of the placeable distances (step S24). The processing device 1 determines one section at which the object is to be placed from the extracted one or more sections (step S25). The processing device 1 refers to the duration of the task of the selected object and inputs the task to the schedule (step S26).

The processing of steps S23 to S26 is repeated until all of the objects have been selected in step S22. The processing of steps S22 to S26 is repeated until all of the sequences have been selected in step S21. Multiple task plans are generated thereby.

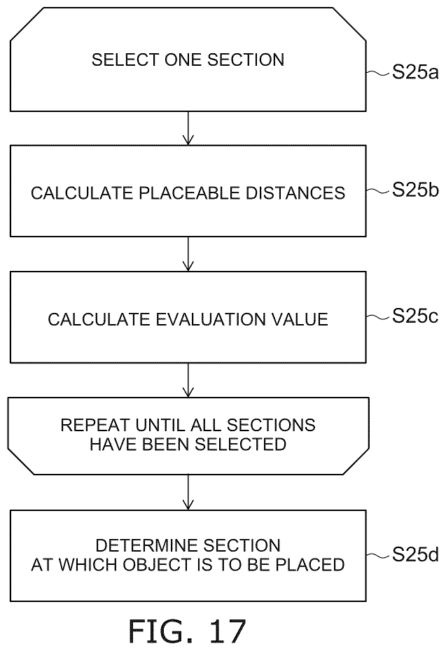

When determining the section at which the object is to be placed in step S25, the processing illustrated in the flowchart of FIG. 17 is performed. The processing device 1 selects one section from the extracted one or more sections (step S25a). The processing device 1 calculates the placeable distances of the sections when the object is placed at the selected section (step S25b). The processing device 1 calculates the evaluation value based on the calculation result of the placeable distances (step S25c). The processing device 1 repeats steps S25a to S25c until all of the extracted sections have been selected. Based on one or more evaluation values, the processing device 1 determines one section at which the object is to be placed from the extracted one or more sections (step S25d).

### Effects of the Embodiment Will Now be Described.

For example, in a manufacturing site of large articles, multiple articles are placed inside a work area; and tasks such as welding, assembly, etc., are performed. The area of the work area is finite, and so it is desirable to be able to effectively utilize the work area when placing the articles. As a result, the duration of all of the tasks can be reduced. However, when placing the articles, there are constraints on the different sizes and shapes of the articles, the orientations of the articles, the area of the work area, etc. It is not easy for a person to examine the appropriate placements and sequence of the articles by considering the constraints. For example, the duration of all of the tasks lengthens, additional expenses are incurred when subcontracting tasks to an outside subcontractor to meet a deadline, etc.

According to the embodiment, the processing device 1 generates a task plan that includes the placements of the objects in the first area and the sequence of the multiple placements. Because the user can adjust the size of the first area and the sizes and shapes of the objects, the processing device 1 can generate a task plan that accounts for the constraints described above. When generating the task plan, the processing device 1 calculates evaluation values based on the states of the first area after placing the objects, and determines the placements and the sequence based on the evaluation values. According to the embodiment, the likelihood of generating a task plan that can more effectively utilize the work area is better than when the placements and the sequence are determined according to preset rules. As a result, the likelihood of being able to generate a task plan that can reduce the work period is better.

For example, the processing device 1 outputs multiple task plans as illustrated in FIGS. 13A to 13C and FIGS. 14A to 14C. The processing device 1 may output a portion of the generated task plans based on the deadline or the work period. As a result, the user can easily ascertain a desirable task plan.

In the example above, the first area and the objects are represented two-dimensionally. The first area and the objects may be represented three-dimensionally. For example, in addition to the first-axis direction and the second-axis direction, multiple sections are arranged in a third-axis direction perpendicular to the first-axis direction and the second-axis direction. Three-dimensional sizes are set for the objects. The placeable distances are calculated in the first to fourth directions D1 to D4 and in a fifth direction corresponding to perpendicularly up.

In the example above, the section is a quadrilateral. The shape of the section is arbitrary as long as multiple sections can be arranged in contact with each other. For example, the section may be triangular, hexagonal, etc. The number of placeable distances calculated for each section corresponds to the number of sides of the section.

In addition to the work area, obstacle areas that include obstacles may be included in the first area. The obstacles are walls, columns, equipment, etc. A section in which an obstacle is present cannot be utilized for a task. One or more sections are assigned to each work area and obstacle area. The user sets each section to be one of an occupied section or an unoccupied section. The occupied section cannot be utilized for a task, and is a section at which an obstacle is present, and at which an object cannot be placed. The unoccupied section can be utilized for a task, and is a section at which an object can be placed. When determining the placements of the objects, the processing device 1 determines whether each section is an occupied section or an unoccupied section. The processing device 1 performs the placement of the object, the calculation of the placeable distances, the calculation of the evaluation value, etc., for multiple occupied sections.

In such a case, the user may be able to switch the setting of occupied section or unoccupied section for each section in the first area. By switching the setting, task plans can be checked for when a section at which a movable obstacle is placed is set to be an occupied section and for when the section is set to be an unoccupied section. For example, it is easy to compare whether it is better to invest time to move the obstacle, or to advance the tasks without moving the obstacle. The task plan that has the shorter work period is easily obtained.

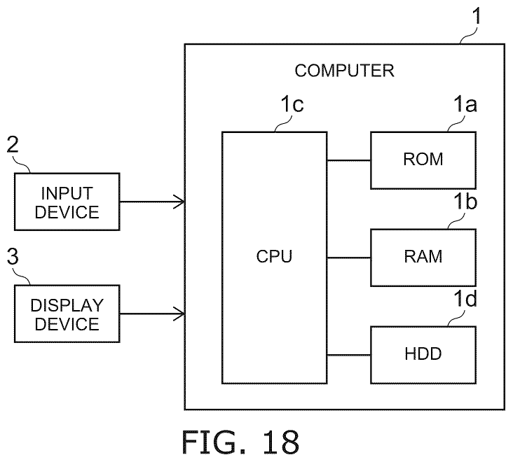

FIG. 18 is a block diagram illustrating a hardware configuration of the processing device according to the embodiment.

For example, the processing device 1 is a computer and includes ROM (Read Only Memory) 1a, RAM (Random Access Memory) 1b, a CPU (Central Processing Unit) 1c, and a HDD (Hard Disk Drive) 1d.

The ROM 1a stores programs controlling the operations of the computer. The ROM 1a stores programs necessary for causing the computer to realize the processing described above. The RAM 1b functions as a storage area into which programs stored in the ROM 1a are loaded. The CPU 1c includes a processing circuit. The CPU 1c reads control programs stored in the ROM 1a and controls operations of the computer according to the control programs. The CPU 1c loads various data obtained by the operations of the computer into the RAM 1b. The HDD 1d stores data necessary for reading and/or data obtained in the reading process. For example, the HDD 1d functions as the storage device 4 illustrated in FIG. 1.

The processing and functions of the processing device 1 may be realized by collaboration between more computers.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another recording medium.

For example, the data that is recorded in the recording medium can be read by a computer (or an embedded system). The recording format (the storage format) of the recording medium is arbitrary. For example, the computer reads the program from the recording medium and causes the CPU to execute the instructions recited in the program based on the program. In the computer, the acquisition (or the reading) of the program may be performed via a network.

According to the processing device 1 according to the embodiments above, a task plan that has a shorter work period can be generated. Similarly, according to the processing system 10 including the processing device 1, the generation method causing the computer to generate the task plan, and the program causing the computer to perform the processing described above, a task plan that has a shorter work period can be generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A processing device, configured to:
refer to a first area corresponding to a work area where a plurality of tasks related to a plurality of articles is performed, the first area including a plurality of sections;
refer to a plurality of objects corresponding to the plurality of articles, a size and a duration of the task being set for each of the plurality of objects; and
generate a task plan by using the plurality of sizes and the plurality of durations, the task plan including
placements of the plurality of objects in the first area, and
a sequence of the plurality of placements,
the processing device being configured to calculate an evaluation value based on a state of the first area after placing at least one of the plurality of objects, and determine the plurality of placements and the sequence based on the evaluation value.

2. The processing device according to claim 1, wherein
the generation of the task plan includes:
determining whether or not at least one of the plurality of objects is placeable by referring to states of the first area at different times; and
determining the plurality of placements and the sequence by removing, from the first area, one or more of the objects for which the duration has elapsed from being placed in the first area.

3. The processing device according to claim 1, wherein
the task plan further includes a schedule showing a relationship of the sequence and time.

4. The processing device according to claim 3, wherein
a display device is caused to display the schedule and the plurality of placements in the first area.

5. The processing device according to claim 1, wherein
the generation of the task plan includes:
selecting one of the plurality of objects;
extracting one or more of the sections at which the selected object can be placed;
calculating one or more of the evaluation values when placing the selected object in the one or more sections; and
determining the placement of the selected object based on the one or more evaluation values.

6. The processing device according to claim 5, wherein
the plurality of sections is arranged along a first-axis direction and a second-axis direction,
the first-axis direction and the second-axis direction are orthogonal to each other,
the calculating of the one or more evaluation values includes:
calculating a plurality of placeable distances respectively in a first direction, a second direction, a third direction, and a fourth direction for each of the sections after the selected object is placed, the first direction being parallel to the first-axis direction, the second direction being opposite to the first direction, the third direction being parallel to the second-axis direction, the fourth direction being opposite to the third direction; and
calculating the evaluation value based on the plurality of placeable distances.

7. The processing device according to claim 1, wherein
each of the plurality of sections is set to be one of an occupied section or an unoccupied section, and
the processing device generates the task plan including the placements of the plurality of objects and the sequence of the plurality of placements for one or more of the unoccupied sections included in the first area.

8. A generation method, comprising:
causing a computer to
refer to a first area corresponding to a work area where a plurality of tasks related to a plurality of articles is performed, the first area including a plurality of sections,
refer to a plurality of objects corresponding to the plurality of articles, a size and a duration of the task being set for each of the plurality of objects, and
generate a task plan by using the plurality of sizes and the plurality of durations, the task plan including
placements of the plurality of objects in the first area, and
a sequence of the plurality of placements,
the generation method causing the computer to calculate an evaluation value based on a state of the first area after placing at least one of the plurality of objects, and determine the plurality of placements and the sequence based on the evaluation value.

9. A non-transitory computer-readable storage medium configured to store a program,
the program, when executed by a computer, causing the computer to:
refer to a first area corresponding to a work area where a plurality of tasks related to a plurality of articles is performed, the first area including a plurality of sections;
refer to a plurality of objects corresponding to the plurality of articles, a size and a duration of the task being set for each of the plurality of objects; and
generate a task plan by using the plurality of sizes and the plurality of durations, the task plan including
placements of the plurality of objects in the first area, and
a sequence of the plurality of placements,
the program, when executed by the computer, causing the computer to calculate an evaluation value based on a state of the first area after placing at least one of the plurality of objects, and determine the plurality of placements and the sequence based on the evaluation value.
